(19) United States
(12) Patent Application Publication
(10) Pub. No.: US 2017/0028240 A1
(43) Pub. Date: Feb. 2, 2017

(54) METHOD FOR THE SUPPRESSION OF FIRE

(71) Applicant: THE CHEMOURS COMPANY FC, LLC, Wilmington, DE (US)

(72) Inventor: MARK L. ROBIN, Middletown, DE (US)

(21) Appl. No.: 15/218,201

(22) Filed: Jul. 25, 2016

Related U.S. Application Data
(60) Provisional application No. 62/199,449, filed on Jul. 31, 2015.

(51) Int. Cl. A62C 99/00; A62C 2/04; A62D 1/00

(52) U.S. Cl. CPC A62C 99/0018; A62D 1/0092; A62C 2/04

(57) ABSTRACT

A method for suppressing a fire at a burning material comprising delivering to said burning material (a) an inert gas selected from nitrogen, argon and carbon dioxide or mixtures thereof, and (b) a fluoroolefin compound selected from the group consisting of fluoroolefins, hydrofluoroolefins, hydrochlorofluoroolefins and hydrobromofluoroolefins, or mixtures thereof, (a) and (b) being delivered in a combined concentration sufficient to extinguish the fire.

### BACKGROUND INFORMATION

Field of the Disclosure

This disclosure relates in general to the field of fire extinguishing compositions and methods for delivering a fire extinguishing composition to or within a protected hazard area.

Description of the Related Art

Numerous agents and methods of firefighting are known and can be selected for a particular fire, depending upon factors such as its size, location and the type of combustible materials involved. Halogenated hydrocarbon firefighting agents have traditionally been utilized in the fire protection industry, in applications including fire prevention applications, which leave a breathable atmosphere in an enclosed area, total flooding applications, wherein an enclosure is completely filled (“flooded”) with an effective amount of the agent (e.g., computer rooms, storage vaults, telecommunications switching gear rooms, libraries, document archives, petroleum pipeline pumping stations, and the like), or in streaming applications wherein the agent is directed towards the location of the fire (e.g., commercial hand-held extinguishers). Such extinguishing agents are not only effective but, unlike water, also function as “clean extinguishing agents”, causing little, if any, damage to the enclosure or its contents.

The most commonly used halogenated hydrocarbon extinguishing agents have been the bromine-containing compounds bromotrifluoromethane (CF₃Br, Halon1301) and bromochlorodifluoromethane (CF₂ClBr, Halon1211). These bromine-containing halocarbons are highly effective in extinguishing fires and can be dispensed either from portable streaming equipment or from an automatic total flooding system activated either manually or by some method of fire detection. However, due to the presence of Br and Cl atoms within their molecular structure these compounds have been linked to the destruction of stratospheric ozone (“ozone depletion”). The Montreal Protocol and its attendant amendments have mandated that Halon1211 and 1301 production be discontinued.

It is therefore an object of the present invention to provide a method for extinguishing fires which does not lead to the depletion of stratospheric ozone.

Thus, there is a need in this field for substitutes or replacements for the commonly used, bromine-containing fire extinguishing agents. Such substitutes should have a low ozone depletion potential (ODP); should have the ability to efficiently extinguish, control, and prevent fires, e.g., Class A (trash, wood, or paper), Class B (flammable liquids or greases), and/or Class C (energized electrical equipment) fires; and should be “clean extinguishing agents”, i.e., be electrically non-conducting, volatile or gaseous, and leave no residue following their use. Preferably, substitutes will also be low in toxicity, not form flammable mixtures in air, and have acceptable thermal and chemical stability for use in extinguishing applications. In addition, suitable Halon replacements should exhibit a minimum impact on climate change, i.e., they should not contribute significantly to global warming, being characterized by a low global warming potential (GWP).

Various different fluorinated hydrocarbons have been suggested for use as fire fighting agents, as described by M. L. Robin, “Halogenated Fire Suppression Agents”, in Halon Replacements: Technology and Science, A. W. Miziolek and W. Tsang, eds., ACS Symposium Series 611, American Chemical Society, Washington, D.C., August 1994, Chapter 9. For example, hydrobromofluorocarbons (HBFCs) and hydrochlorofluorocarbons (HCFCs) have been proposed as substitutes for the Halon agents. Although effective as fire extinguishing agents, and characterized by lower ODPs compared to the Halons, HBFCs and HCFCs still contribute to the destruction of stratospheric ozone, and as a result their use and production has been slated for phase out.

In U.S. Pat. No. 5,124,053 the use of hydrofluorocarbons (HFCs) as fire extinguishing agents is disclosed. The HFCs are characterized by efficient fire suppression, zero ODP, low toxicity, and are also “clean” agents, leaving no residues following their use. The HFCs are, however, characterized by moderate GWPs and hence contribute somewhat to global warming.

It is therefore an object of the present invention to provide a method for extinguishing fires which does not lead to significant contributions to global warming.

Fluoroolefins have been suggested for use as fire fighting agents, as described by Nappa, et. al., in U.S. Pat. No. 8,287,752. For example, fluoroolefins of formula E- or Z—R₁CH═CHR₂, wherein R₁ and R₂ are, independently, C1 to C6 perfluoroalkyl groups; and wherein said at least one fluoroolefin has a global warming potential of less than about 50, and said flame suppression composition has an Ozone Depletion Potential of not greater than 0.05 have been proposed as substitutes for the Halon agents.

### SUMMARY

In one embodiment, disclosed is a flooding method for suppressing a fire at a burning material comprising delivering to said burning material (a) an inert gas and (b) a fluoroolefin, stored as a compressed liquid in a separate container, selected from the group consisting of a hydrofluoroolefins, hydrochlorofluoroolefins, hydrobromofluoroolefins, and mixtures thereof, (a) and (b) being delivered in a combined concentration sufficient to extinguish the fire, wherein the inert gas (a) is delivered to said burning material in a concentration of at least 5% v/v, and compound (b) is delivered to said burning material in a concentration of at least 1% v/v.

The foregoing general description and the following detailed description are exemplary and explanatory only and are not restrictive of the invention, as defined in the appended claims.

### DETAILED DESCRIPTION

In one embodiment, disclosed is a flooding method for suppressing a fire at a burning material comprising delivering to said burning material (a) an inert gas and (b) a fluoroolefin, stored as a compressed liquid in a separate container, selected from the group consisting of a hydrofluoroolefins, hydrochlorofluoroolefins, hydrobromofluoroolefins, and mixtures thereof, (a) and (b) being delivered in a combined concentration sufficient to extinguish the fire, wherein the inert gas (a) is delivered to said burning material in a concentration of at least 5% v/v, and compound (b) is delivered to said burning material in a concentration of at least 1% v/v.

Many aspects and embodiments have been described above and are merely exemplary and not limiting. After reading this specification, skilled artisans appreciate that other aspects and embodiments are possible without departing from the scope of the invention.

For the purpose of promoting an understanding of the principles of the invention, reference will now be made to preferred embodiments of the invention and specific language will be used to describe the same. It will nevertheless be understood that no limitation of the scope of the invention is thereby intended, such alterations, further modifications and applications of the principles of the invention as described herein being contemplated as would normally occur to one skilled in the art to which the invention relates.

In accordance with the present invention, it has been found that the use of a hybrid fluoroolefin/inert gas extinguishing system eliminates or significantly reduces the problems described above.

In accordance with one embodiment of the present invention, there is provided a method for extinguishing fires which comprises a system consisting of a fluoroolefin fire suppression agent stored in a suitable cylinder, and an inert gas fire suppression agent stored in a second suitable cylinder. Both the fluoroolefin and inert gas cylinders are connected via the appropriate piping and valves to discharge nozzles located within the hazard being protected. Upon detection of a fire, the suppression system is activated. In one embodiment of the invention, the fluoroolefin agent and the inert gas agent are released from their respective storage cylinders simultaneously, affording delivery of the fluoroolefin and inert gas to the protected hazard at the same time. Typical detection systems, for example smoke detectors, infrared detectors, air sampling detectors, etc. may be employed to activate the system, and a delay between detection and agent delivery may be employed if deemed appropriate to the hazard. In a further embodiment of the invention, upon detection of the fire the inert gas agent is delivered to the enclosure first, and the fluoroolefin agent is delivered at a later time, either during or after the inert gas discharge, depending upon the needs of the particular fire scenario.

It should be understood that fire extinguishing using a “flooding” method, as accomplished in accordance with the present invention, provides sufficient extinguishing agent(s) to flood an entire enclosure or room in which the fire is detected. Assuming perfect mixing of gases in the enclosure, the composition of the gases, including the extinguishing agent(s), at the burning material, is identical to the composition of gases at any other location within the enclosure. However, clearly, it is the composition of gases at the burning material which governs whether a fire can be extinguished and, since the mixing of gases in the enclosure may not be homogeneous early in the extinguishing process, the appended claims refer to the gas composition “at the burning material”.

The fluoroolefin agent may be stored in a conventional fire suppression agent storage cylinder fitted with a dip tube to afford delivery of the agent through a piping system. As it well known and practiced widely throughout the industry, the fluoroolefin agent in the cylinder can be superpressurized with nitrogen or another inert gas, typically to levels of 360 or 600 psig. Alternatively, the fluoroolefin agent can be stored as a pure material in a suitable cylinder to which is connected a pressurization system. The fluoroolefin agent is stored as the pure liquefied compressed gas in the storage cylinder under its own equilibrium vapor pressure at ambient temperatures, and upon detection of a fire, the fluoroolefin agent cylinder is pressurized by suitable means, and once pressurized to the desired level, the agent delivery is activated. Such a “piston flow” method for delivering a fire suppression agent to an enclosure, and additional fire suppression agents, including perfluorocarbons, and hydrochlorofluorocarbons, useful in accordance with the present invention, have been described in U.S. Pat. No. 6,112,822 to Robin, et. al. (Sep. 05, 2000), hereby incorporated by reference.

Specific fluoroolefin agents useful in accordance with the present invention include (1) hydrofluoroolefin compounds of the formula E- or Z—R1CH═CHR2, wherein R1 and R2 are, independently, C1 to C6 perfluoroalkyl groups, (2) hydrochlorofluoroolefin compounds and (3) hydrobromofluoroolefins, and mixtures thereof.

Specific hydrofluoroolefin compounds in accordance with the present invention include E and Z—CF₃CH═CHCF₃, E and Z—CF₃CH═CHCF₂CF₃, E and Z—(CF₃)₂CFCH═CHF, E and Z—(CF₃)₂CFCF═CHF, E and Z—(CF₃)₂CH═CHCF₃, E and Z—CF₃CF₂CH═CHF, E and Z—CF₃CF₂CF═CHF, and CF₃CH═CHF and mixtures thereof.

Specific hydrochlorofluoroolefin compounds in accordance with the present invention include E and Z—CF₃CH═CHCl and CF₃CCl═CH₂, and mixtures thereof.

Specific hydrobromofluoroolefin compounds in accordance with the present invention include E and Z—CF₃CH═CHBr and CF₃CBr═CH₂, and mixtures thereof.

Specific inert gases useful in accordance with the present invention include nitrogen, argon, helium, carbon dioxide, and mixtures thereof.

Unlike conventional inert gas extinguishing systems, the present invention employs the inert gas not to extinguish the fire, but employs the inert gas at concentrations lower than that required for extinguishment. Because the invention employs the inert gas agent for other than extinguishing the fire by itself, the inert gas agent need not be employed at the high concentrations required for extinguishment. The use of lower inert gas concentrations reduces the overall system cost as fewer inert gas cylinders are required for protection of the hazard. Since fewer inert gas cylinders are required, less storage space is required to house the cylinders. Because less inert gas agent is discharged into the enclosure, the pressure developed within the enclosure is reduced, and oxygen levels within the enclosure are not reduced to toxic levels.

In one embodiment of a flooding method for suppressing a fire at a burning material, the inert gas is delivered to the burning material in a concentration of at least 5% v/v and a fluoroolefin is delivered to the burning material in a concentration of at least 1% v/v.

In another embodiment of a flooding method for suppressing a fire, the inert gas is delivered to the burning material in a concentration of from 5 to 53% v/v and a fluoroolefin is delivered to the burning material in a concentration of from 1% to 6% v/v. In yet another embodiment of a flooding method for suppressing a fire, the inert gas is delivered to the burning material in a concentration of from 5 to 34% v/v and a fluoroolefin is delivered to the burning material in a concentration of from 3% to 9% v/v.

In yet another embodiment of a flooding method for suppressing a fire, the inert gas is delivered to the burning material in a concentration of from 5 to 24% v/v and a fluoroolefin is delivered to the burning material in a concentration of from 3% to 9% v/v.

In yet another embodiment of a flooding method for suppressing a fire, the inert gas is delivered to the burning material in a concentration of from 5 to 53% v/v and a fluoroolefin is delivered to the burning material in a concentration of at least 1% v/v.

In yet another embodiment of a flooding method for suppressing a fire, the inert gas is delivered to the burning material in a concentration of from 5 to 34% v/v and a fluoroolefin is delivered to the burning material in a concentration of at least 1% v/v.

In yet another embodiment of a flooding method for suppressing a fire, the inert gas is delivered to the burning material in a concentration of from 5 to 24% v/v and a fluoroolefin is delivered to the burning material in a concentration of at least 1% v/v. In yet another embodiment of a flooding method for suppressing a fire, the inert gas is delivered to the burning material in a concentration of from 8 to 20% v/v and a fluoroolefin is delivered to the burning material in a concentration of at least 1% v/v.

In yet another embodiment of a flooding method for suppressing a fire, the inert gas is delivered to the burning material in a concentration of 53% v/v or less, and a fluoroolefin is delivered to the burning material in a concentration of at least 1% v/v.

In yet another embodiment of a flooding method for suppressing a fire, the inert gas is delivered to the burning material in a concentration of at least 5% v/v, and a fluoroolefin is delivered to the burning material in a concentration of from 1 to 6% v/v.

In another embodiment of a flooding method of a flooding method for suppressing a fire, an inert gas and a fluoroolefin are delivered to the burning material in quantities sufficient to reduce an oxygen concentration at the burning material to less than 20% on a volume/volume basis.

In yet another embodiment of a flooding method of a flooding method for suppressing a fire, an inert gas and a fluoroolefin are delivered to the burning material in quantities sufficient to reduce an oxygen concentration at the burning material to a range of between 16% and 20% inclusive, on a volume/volume basis.

In addition to the above benefits, it has been discovered that the present invention affords fire extinguishment at fluoroolefin concentrations unexpectedly lower than that required with conventional fluoroolefin fire suppression systems. This results in significantly lowered overall system costs, as the fluoroolefin agents are expensive and represent the major portion of the cost of a fluoroolefin fire suppression system.

The invention will be further described with reference to the following specific Examples. However, it will be understood that these Examples are illustrative and not restrictive in nature.

### EXAMPLE 1

The effect of lowered oxygen levels on the concentration of E—(CF₃)₂CFCH═CHF (E-1,3,4,4,4-pentafluoro-3-trifluoromethyl -1-butene, E-HFO-1438ezy) required for the extinguishment of n-heptane flames was examined in a cup burner apparatus, as described in M. Robin and Thomas F. Rowland, “Development of a Standard Cup Burner Apparatus: NFPA and ISO Standard Methods, 1999 Halon Options Technical Working Conference, Apr. 27-29, 1999, Albuquerque, N. Mex. The cup burner method is a standard method for determining extinguishing concentrations for gaseous extinguishants, and has been adopted in both national and international fire suppression standards, for example NFPA 2001 Standard on Clean Agent Fire Extinguishing Systems and ISO 14520: Gaseous Fire-Extinguishing Systems. A mixture of oxygen, nitrogen and E-HFO-1438ezy flowed through a 85 mm (ID) Pyrex chimney around a 28 mm (OD) fuel cup. The chimney consisted of a 533 mm length of 85 mm ID glass pipe. The cup had a 45.degree. ground inner edge. A wire mesh screen and a 76 mm (3 inch) layer of 3 mm (OD) glass beads were employed to provide thorough mixing of air, nitrogen and E-HFO-1438ezy. n-Heptane was gravity fed to the cup burner from a liquid fuel reservoir consisting of a 250 mL separatory funnel mounted on a laboratory jack, which allowed for an adjustable and constant liquid fuel level in the cup. The fuel was lit with a propane mini-torch, the chimney was placed on the apparatus, and the oxygen and nitrogen flows initiated. The fuel level was then adjusted such that the ground inner edge of the cup was completely covered. A 90 second preburn period was allowed, and the E-HFO-1438ezy concentration in the oxygen/nitrogen stream increased in small increments, with a waiting period of 10 seconds between increases in E-HFO-1438ezy flow. After flame extinction, the used fuel was drained and the test repeated several times with fresh fuel. Immediately following flame extinction, a sample of the gas stream at a point near the lip of the cup was collected in a precision gas syringe. The sample was then subjected to gas chromatographic analysis. Calibration was performed by preparing standards. Results are shown in Table 1.

TABLE 1
Extinguishing Concentrations of E-HFO-1438ezy for n-
Heptane Flames.

| | | | Nitrogen added to air to |
|---|---|---|---|
| | | | achieve indicated |
| | | E-1438ezy Ext. | Oxygen concentration |
| Run | % Oxygen v/v | Conc % v/v | % v/v |
| 1 | 16.6 | 1.9 | 20.5 |
| 2 | 17.2 | 2.5 | 17.7 |
| 3 | 18.3 | 3.0 | 12.4 |
| 4 | 19.8 | 4.2 | 5.3 |
| 5 | 20.5 | 5.9 | 1.9 |

The results of Table 1 demonstrate that flame extinguishment is achieved with lowered amounts of both the inert gas and the hydrofluoroolefin agent compared to conventional inert gas or hydrofluoroolefin suppression systems. To extinguish an n-heptane flame with nitrogen alone would require a nitrogen concentration of 32.2% v/v nitrogen [NFPA 2001, Table A.5.4.2(a)]. Employing the combination of an inert gas and a hydrofluoroolefin agent of the present invention, for example under the conditions of Run 3, where the oxygen concentration is reduced to 18.3% v/v, extinguishment is afforded at an added nitrogen concentration of 12.4% v/v (which reduces the O₂ content to 20.9−20.9*12.4=18.3%) and an E-HFO-1438ezy concentration of 3.0%.

Hence the requirements for both nitrogen and E-HFO-1438ezy have been significantly reduced compared to using either alone, which would lead to a substantial reduction in overall system cost, while avoiding atmospheric conditions that are hazardous to personnel.

### EXAMPLE 2

Example 1 was repeated, employing E—CF₃CH═CHCF₃ (E-1,1,1,4,4,4-hexafluoro-2-butene, E-HFO-1336mzz) as the hydrofluoroolefin agent. Results are shown in Table2, where it can be seen that the use of the present invention leads to reduced requirements of both the inert gas and the hydrofluoroolefin agent compared to conventional systems.

TABLE 2
Extinguishing Concentrations of E-HFO-1336mzz for n-
Heptane Flames

| | | E-HFO- | Nitrogen added to air to |
|---|---|---|---|
| | % Oxygen | 1336mzz Ext. | achieve indicated oxygen |
| Run | v/v | Conc., % v/v | concentration, % v/v |
| 1 | 16.5 | 2.8 | 21.0 |
| 2 | 18.0 | 4.4 | 13.9 |
| 3 | 19.6 | 5.4 | 6.2 |

### EXAMPLE 3

Example 1 was repeated, employing E-CF₃CH═CHCI (E-1-Chloro-3,3,3-trifluoropropene, E-HCFO-1233zd) as the hydrochlorofluoroolefin agent. Results are shown in Table 3, where it can be seen that the use of the present invention leads to reduced requirements of both the inert gas and the hydrofluoroolefin agent compared to conventional systems.

TABLE 3
Extinguishing Concentrations of E-HCFO-1233zd for n-
Heptane Flames

| | | | Nitrogen added |
|---|---|---|---|
| | | | to air to achieve |
| | | E-HCFO- | indicated oxygen |
| | | 1233zd Ext. | concentration, % |
| Run | % Oxygen v/v | Conc., % v/v | v/v |
| 1 | 14.7 | 2.1 | 29.7 |
| 2 | 155.5 | 3.2 | 25.8 |
| 3 | 16.3 | 3.9 | 22.0 |
| 4 | 17.1 | 4.3 | 18.2 |
| 5 | 18.7 | 5.3 | 10.5 |

### EXAMPLE 4

Example 1 was repeated, employing E—(CF3)2CFCH═CHF (E-1,3,4,4,4-pentafluoro-3-trifluoromethyl-1-butene, E-HFO-1438ezy)as the hydrofluoroolefin and carbon dioxide in place of nitrogen. Results are shown in Table 4, where it can be seen that the use of the present invention leads to reduced requirements of both the inert gas and the hydrofluoroolefin agent compared to conventional systems. Extinguishment of n-heptane flames with carbon dioxide by itself would require 28% v/v CO2 [NFPA 12, Table 5.3.2.2].

TABLE 4
Extinguishing Concentrations of E-HFO-1438ezy plus
CO₂ for n-Heptane Flames

| | % Oxygen | | E-HFO-1438ezy |
|---|---|---|---|
| Run | v/v | % CO₂ v/v | Ext. Conc., % v/v |
| 1 | 18.0 | 9.9 | 4.1 |
| 2 | 17.5 | 13.4 | 3.0 |
| 3 | 16.9 | 16.5 | 2.5 |
| 4 | 16.6 | 19.7 | 1.1 |
| 5 | 16.1 | 22.6 | 0.5 |

### EXAMPLE 5

Example 4 was repeated, employing E-HFO-1336mzz as the hydrofluoroolefin. Results are shown in Table 5, where it can be seen that the use of the present invention leads to reduced requirements of both the inert gas and the hydrofluoroolefin agent compared to conventional systems. Extinguishment of n-heptane flames with carbon dioxide by itself would require 28% v/v CO2 [NFPA 12, Table 5.3.2.2].

TABLE 5
Extinguishing Concentrations of E-HFO-1336mzz plus
CO₂ for n-Heptane Flames

| | % Oxygen | | E-HFC-1336mzz Ext. |
|---|---|---|---|
| Run | v/v | % CO₂ v/v | Conc., % v/v |
| 1 | 19.5 | 0.0 | 6.7 |
| 2 | 18.5 | 6.2 | 5.3 |
| 3 | 18.0 | 9.9 | 4.2 |
| 4 | 17.4 | 13.3 | 3.5 |
| 5 | 16.9 | 16.5 | 2.6 |
| 6 | 16.5 | 19.6 | 1.7 |
| 7 | 16.0 | 22.5 | 0.7 |

### EXAMPLE 6

Example 4 was repeated, employing E-HCFO-1233zd as the hydrochlorofluoroolefin. Results are shown in Table 5, where it can be seen that the use of the present invention leads to reduced requirements of both the inert gas and the hydrochlorofluoroolefin agent compared to conventional systems. Extinguishment of n-heptane flames with carbon dioxide by itself would require 28% v/v CO2 [NFPA 12, Table 5.3.2.2].

TABLE 6
Extinguishing Concentrations of E-HCFO-1233zd plus
CO2 for n-Heptane Flames

| | | % Oxygen | E-HCFO-1233zd Ext. |
|---|---|---|---|
| Run | % CO₂, v/v | v/v | Conc., % v/v |
| 1 | 16.5% | 16.8% | 3.0% |
| 2 | 19.5% | 16.4% | 2.0% |
| 3 | 22.5% | 16.0% | 1.05 |
| 4 | 24/2% | 15.8% | 0.4% |

Analysis of Tables 1 through 6 shows that the extinguishment of these fires is accomplished by delivering to the fire (1) an amount of an inert gas sufficient to reduce the oxygen concentration to a certain level and (2) an amount of a fluoroolefin agent at a concentration sufficient to provide, when combined with the inert gas, extinguishment of the fire.

Sufficient inert gas is delivered to reduce the oxygen, at the fire, to a level ranging from about 10% to about 20% v/v oxygen, preferably about 14% to 20% v/v oxygen, and more preferably, to provide an atmosphere in which human activity is unimpaired, from about 16% to about 20% v/v oxygen.

Assuming an ambient oxygen level of 21% v/v oxygen, reduction to 10% to 20% oxygen would require an inert gas concentration of from about 52.4 to 4.8% v/v. Reduction of the oxygen level to 14% to 20% v/v would require an inert gas concentration of from 33.3 to 4.8%. Reduction of the oxygen level to 16% to 20% v/v would require an inert gas concentration of from 23.8 to 4.8%.

The concentration of fluoroolefin required for extinguishment depends upon the particular fluoroolefin being employed. For example, from Table 1 it can be seen that in the case of E-HFO-1438ezy, the concentration required ranges from about 1% to 6% v/v, preferably 2% to 6%, and most preferably from about 3% to 4% v/v.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. A flooding method for suppressing a fire at a burning material comprising delivering to said burning material (a) an inert gas and (b) a fluoroolefin, stored as a compressed liquid in a separate container, selected from the group consisting of a hydrofluoroolefins, hydrochlorofluoroolefins, hydrobromofluoroolefins, and mixtures thereof, (a) and (b) being delivered in a combined concentration sufficient to extinguish the fire, wherein the inert gas (a) is delivered to said burning material in a concentration of at least 5% v/v, and compound (b) is delivered to said burning material in a concentration of at least 1% v/v.

2. A method in accordance with claim 1, wherein each gas (a) and (b) is delivered in less than an extinguishing concentration when used alone.

3. A method in accordance with claim 1, wherein the hydrofluoroolefin is selected from the group comprising E and Z—CF₃CH═CHCF₃, E and Z—CF₃CH═CHCF₂CF₃, E and Z—(CF₃)₂CFCH═CHF, E and Z—(CF₃)₂CFCF═CHF, E and Z—(CF₃)₂CH═CHCF₃, E and Z—CF₃CF₂CH═CHF, E and Z—CF₃CF₂CF═CHF, and CF₃CH═CHF and mixtures thereof.

4. A method in accordance with claim 1, wherein the hydrofluoroolefin is selected from the group of compounds of the formula E- or Z—R1CH═CHR2, wherein R1 and R2 are, independently, C1 to C6 perfluoroalkyl groups, and mixtures thereof.

5. A method in accordance with claim 1, wherein the fluoroolefin is selected from E and Z—CF₃CH═CHCl and CF₃CCl=CH₂, and mixtures thereof.

6. A method in accordance with claim 1, wherein the fluoroolefin is selected from the group comprised of E and Z—CF₃CH═CHBr and CF₃CBr═CH₂, and mixtures thereof.

7. A method in accordance with claim 1, wherein the inert gas is delivered to the burning material prior to delivering compound (b) to the burning material.

8. A method in accordance with claim 1, wherein compound (b) is delivered to the burning material prior to delivering the inert gas to the burning material.

9. A method in accordance with claim 1, wherein the inert gas and compound (b) are delivered simultaneously to the burning material.

10. A method in accordance with claim 1, wherein the inert gas is selected from the group consisting of nitrogen, argon, helium, carbon dioxide, and mixtures thereof.

11. A method in accordance with claim 1, wherein gases (a) and (b) are delivered to the burning material in quantities sufficient to reduce an oxygen concentration, at the burning material, to less than 20% v/v.

12. A method in accordance with claim 1, wherein gases (a) and (b) are delivered to the burning material in quantities sufficient to reduce an oxygen concentration, at the burning material, to a range of 16% to 20% v/v.

13. A method in accordance with claim 1, wherein the concentration of inert gas at said burning material is in the range of about 5% to about 53% v/v, and the concentration of compound (b) at said burning material is in the range of about 1% to about 6% v/v.

14. A method in accordance with claim 13, wherein the concentration of inert gas at said burning material is in the range of about 5% to about 34% v/v, and the concentration of compound (b) at said burning material is in the range of about 3% to about 9% v/v.

15. A method in accordance with claim 13, wherein the concentration of inert gas at said burning material is in the range of about 5% to about 24% v/v, and the concentration of compound (b) at said burning material is in the range of about 3% to about 9% v/v.

16. A method in accordance with claim 1, wherein the inert gas is delivered to the burning material in an amount sufficient such that the concentration of inert gas at the burning material is in the range of about 5% to about 53% v/v.

17. A method in accordance with claim 16, wherein the inert gas is delivered to the burning material in an amount sufficient such that the concentration of inert gas at the burning material is in the range of about 5% to about 34% v/v.

18. A method in accordance with claim 16, wherein the inert gas is delivered to the burning material in an amount sufficient such that the concentration of inert gas at the burning material is in the range of about 5% to about 24% v/v.

19. A method in accordance with claim 16, wherein the inert gas is delivered to the burning material in an amount sufficient such that the concentration of inert gas at the burning material is about 8% to about 20% v/v.

20. A method in accordance with claim 1, wherein the inert gas is delivered to the burning material in an amount such that the inert gas concentration at the burning material is 53% v/v or less.

21. A method in accordance with claim 1, wherein compound (b) is delivered to the burning material in an amount sufficient such that the concentration of compound (b) at the burning material is in the range of about 1% to about 6% v/v.
